(19) United States
(12) Patent Application Publication
(10) Pub. No.: US 2026/0341968 A1
(43) Pub. Date: Oct. 29, 2026

(54) SYSTEM AND METHOD FOR A DYNAMIC POLARIZATION RECONFIGURABLE METASURFACE FOR ADAPTIVE SIGNAL CONTROL AND SECURE WIRELESS COMMUNICATION

(71) Applicant: Dell Products LP, Round Rock, TX (US)

(72) Inventors: Tejinder Singh, Manotick (CA); Navjot Kaur Khaira, Manotick (CA); Harpreet S. Narula, Austin, TX (US)

(73) Assignee: Dell Products LP, Round Rock, TX (US)

(21) Appl. No.: 19/193,211

(22) Filed: Apr. 29, 2025

(51) Int. Cl. H01Q 15/00; H01Q 1/38

(52) U.S. Cl. CPC H01Q 15/0086; H01Q 1/38; H01Q 15/002; H01Q 15/0026

(57) ABSTRACT

A system and method comprising a reconfigurable metasurface comprising a metasurface hardware controller and a plurality of reconfigurable metasurface unit cells each including a plurality of metallization nodes, a plurality of metal-insulator-transition (MIT) node membranes disposed onto a surface of a second dielectric layer and separated from the metallization nodes by a first dielectric layer, a plurality of addressable heaters formed to selectively pulse heat to phase change material of each of the plurality of MIT node membranes to switch between an insulative state and conductive state, and a conductive c-shaped resonator formed below the second dielectric layer to electromagnetically couple to a plurality of metallization nodes corresponding to the MIT node membranes that are switched to the conductive state for control over converting an incident RF signal in the first polarization state to a reflected RF signal in a second polarization state by the reconfigurable metasurface.

### FIELD OF THE DISCLOSURE

The present disclosure generally relates to metasurface systems for reflecting or directing electromagnetic (EM) waves of radiofrequency (RF) signals used in wireless communications for communication between information handling systems. The present disclosure more specifically relates systems and methods for a reconfigurable metasurface unit cell array with a plurality of reconfigurable metasurface unit cells to reflect EM waves such as radiofrequency signals transmitted between a source information handling system and a target or receiving information handling system while dynamically changing the polarization of the EM wave for those RF signals as an added security measure.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities that may include wireless communications. The information handling system may be used to operate a wireless interface adapter and radio system for transmission of radio signals to a target receiving wireless device or access point device or to receive radio signals from the target wireless device or access point device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system wirelessly interfacing with a metasurface unit cell array comprising a plurality of unit cells for dynamic polarization shift of electromagnetic (EM) waves of reflected radiofrequency (RF) signals in an RF environment according to an embodiment of the present disclosure;

FIG. 2 is a block diagram illustrating a metasurface unit cell array comprising a plurality of unit cells for dynamic polarization shift of electromagnetic (EM) waves of reflected radiofrequency (RF) signals in an RF environment according to an embodiment of the present disclosure;

FIG. 3A is a top view diagram showing a reconfigurable metasurface unit cell having addressable metal-insulator-transition (MIT) node membranes for dynamic polarization shift of electromagnetic (EM) waves of reflected radiofrequency (RF) signals in an RF environment according to an embodiment of the present disclosure;

FIG. 3B is an exploded perspective view diagram showing a reconfigurable metasurface unit cell having addressable metal-insulator-transition (MIT) node membranes for dynamic polarization shift of electromagnetic (EM) waves of reflected radiofrequency (RF) signals in an RF environment according to an embodiment of the present disclosure;

FIG. 4 is an exploded perspective view diagram showing a reconfigurable metasurface unit cell with the metal-insulator-transition (MIT) membranes at various insulative states and conductive states for polarization shift of electromagnetic (EM) waves according to an embodiment of the present disclosure;

FIG. 5 is an exploded perspective view diagram showing a reconfigurable metasurface unit cell array having addressable MIT node membranes interfacing with an EM wave and reflecting that EM wave of an RF signal off of the surface of the reconfigurable metasurface unit cell array at a different polarization in an RF environment according to an embodiment of the present disclosure; and

FIG. 6 is a flow diagram of a method of securely wirelessly transmitting data via a reconfigurable metasurface unit cell array having addressable metal-insulator-transition (MIT) node membranes for dynamic polarization shift of electromagnetic (EM) waves of reflected radiofrequency (RF) signals in an RF environment according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Wireless data transmission from a transmitting device to a receiving device allows for rapid data transmission and communication between multiple devices. Devices may include wirelessly enabled information handling systems, access point devices, or any computing device, such as internet of things (IOT) devices that are wirelessly capable. With the advent of metasurfaces, these data transmissions may be conducted around objects that would otherwise prevent transmission from a transmitting device to a receiving device. However, metasurfaces often lack the ability to dynamically reconfigure polarization states of reflected EM waves for radiofrequency signals, which limits their effectiveness in environments with varying signal conditions and security requirements. The present specification describes a reconfigurable metasurface unit cell array that can dynamically adjust the polarization of reflected EM signals. This allows for issues such multipath interference and signal security to be alleviated. Indeed, by enabling real-time control over polarization states of the received EM waves, the present specification describes a reconfigurable metasurface unit cell array that addresses the challenge of maintaining clear and secure communication links in complex and dynamic RF environments. Further, the reconfigurable metasurface unit cell array of embodiments herein has addressable metal-insulator-transition (MIT) node membranes incorporated in to metasurface unit cells for dynamic polarization shift of electromagnetic (EM) waves of reflected radiofrequency (RF) signals in an RF environment.

Thus, the present specification describes a reconfigurable metasurface to dynamically manipulate an EM wave of an RF signals such that a received EM wave having a first polarization may be reflected from the surface of the reconfigurable metasurface unit cell array having a second polarization. This controlled change to polarization may provide for improved filtering of multipath interference that may occur along with one polarization of the RF signal but not the second reflected polarization state of the RF signal in embodiments. Further, the reconfigurable metasurface may be instructed to control change to polarization from one polarization of the RF signal to a second reflected polarization state of the RF signal and coordinate that changed polarization with transmission to the source or receiver wireless computing devices in an RF environment to provide for improved security for the transmitted RF signal in other embodiments.

In an embodiment, the reconfigurable metasurface unit cell array may include a metasurface hardware controller and a metasurface power management unit (PMU) to provide power to the metasurface hardware controller. In an embodiment, the reconfigurable metasurface unit cell array includes a plurality of reconfigurable metasurface unit cells. Each of the reconfigurable metasurface unit cells including a plurality of metallization nodes disposed in a semicircular configuration on a first dielectric layer, a plurality of metal-insulator-transition (MIT) node membranes made of a phase change material disposed in a corresponding semicircular configuration onto a surface of a second dielectric layer formed below the first dielectric layer, a plurality of heaters formed around at least a portion of each of the plurality of MIT node membranes to selectively heat each of the plurality of MIT node membranes to switch the MIT node membranes between an insulative state and conductive state, and a c-shaped resonator formed below the second dielectric layer in embodiments herein. The c-shaped resonator formed below the second dielectric layer to, when any of the plurality of MIT node membranes are switched to the conductive state, conductively couple to respective plurality of metallization nodes at the surface of the reconfigurable metasurface unit cell to dynamically re-polarize the EM wave incident to a surface of the reconfigurable metasurface unit cell array to a second polarization state of the reflected EM waves of an RF signal in embodiments of the present disclosure.

In an embodiment, each of the reconfigurable metasurface unit cells include a plurality of grounding source arms formed around at least a portion of the MIT node membranes and forming a voltage gap between each of the plurality of grounding source arms and respective plurality heater arms of the heater structures on or in the second dielectric layer of reconfigurable unit cells. The voltage gap between the grounding source arms and the heater arms of the heaters to create a voltage difference between the plurality of grounding source arms and the plurality of heaters for heating. Each of the reconfigurable metasurface unit cells includes a contact pads operatively coupled to each of the plurality of heaters, the contact pads operatively coupling each of the plurality of heaters to the metasurface PMU for each of the plurality of heaters to receive a voltage as directed by the metasurface hardware controller to generate heat pulses for transition of MIT node membranes between conductive and dielectric states. As such, the metasurface hardware controller may provide output to each of the heaters of each of the reconfigurable metasurface unit cells in order to dynamically change conductive state of MIT node membranes and conductivity to the surface metallization nodes to shift or adjust the polarization of incoming EM waves to a second polarization state of the reflected EM waves in the reflected RF signal. In an embodiment, each reconfigurable metasurface unit cell may cooperate with neighboring reconfigurable metasurface unit cell in order to engineer the phase and amplitude response across the surface of the reconfigurable metasurface unit cell array such that, together, they create a macroscopic EM boundary condition that reflect the EM waves of the reflected RF signal with the desired, second polarization state. This reconfiguration capability of each of the reconfigurable metasurface unit cells and the reconfigurable metasurface unit cell array as a whole enables the reconfigurable metasurface unit cell array to fine-tune the polarization adjustment of incident EM waves, switching between linear, circular, and elliptical polarizations in the reflected EM waves of an RF signal depending on addressing to the MIT node membranes of metasurface unit cells across the reconfigurable metasurface unit cell array. This allows the reconfigurable metasurface unit cell array to be used to increase security related to RF signal wireless transmissions via coordination via out of band communication of the polarization shift with the transmitting and receiving wireless computing devices in the RF environment such that those antenna not capable of receiving EM waves at that polarization cannot intercept these wireless transmissions in embodiments herein. Further, transition of polarization for an RF signal may also reduce interference that may interfere with a first type of polarized incoming RF signal, but may be shed or reduced at the second polarization state in the reflected RF signal in other embodiments.

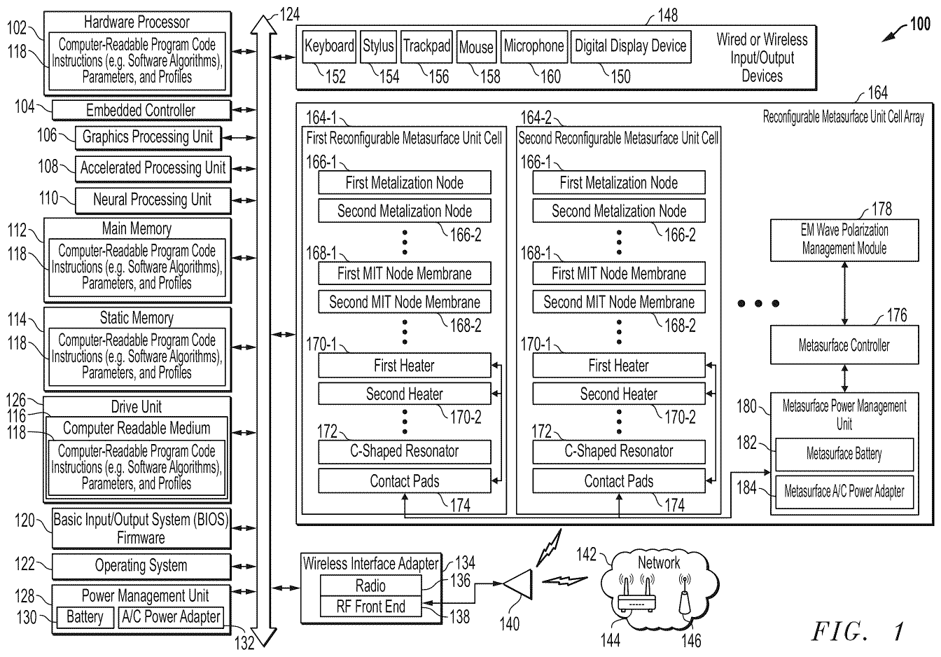

Turning now to the figures, FIG. 1 illustrates an information handling system 100 similar to the information handling systems according to several aspects of the present disclosure that may operate as a source or target radiofrequency device for use with the reconfigurable metasurface unit cell array 162 of the embodiments of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Machine readable code instructions stored in static memory 114, main memory 112, or drive unit 126 may be involved in invoking such machine readable code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a digital display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute machine readable code instructions (e.g., software algorithms) parameters, and profiles 118 that may operate on servers or systems, remote data centers, or on-box in individual client information handling systems according to various embodiments herein. In some embodiments, it is understood any or all portions of machine readable code instructions (e.g., software algorithms) parameters, and profiles 118 may operate on a plurality of information handling systems 100.

The information handling system 100 may include the hardware processor 102 such as a central processing unit (CPU) or other hardware processing resource (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing machine readable code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, digital display device 150, stylus 154, trackpad 156, microphone 160, among other peripheral devices.

As described herein, the information handling system 100 further includes a digital display device 150. The digital display device 150 in an embodiment may function as a liquid crystal display (LCD), an organic light emitting diode (OLED), a flat panel display, or a solid-state display. It is appreciated that the digital display device 150 may be wired or wireless and may be an external digital display device 150 that allows a user to increase the desktop area by extending the desktop in an embodiment. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the digital display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among plural devices such as with Bluetooth® or to a network 142 such as with a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among any wireless peripheral device to be paired or paired with the information handling system 100 or other information handling systems.

In other embodiments, the wireless interface device 134 with its radio 136, RF front end 138 and antenna 140 is used to communicate with a WWAN or and WLAN which may each include an AP 144 or base station 146 used to operatively couple the information handling system 100 to a network 142 via the wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols. It is appreciated that the information handling system 100 may wirelessly communicate with a target receiver device 178 via the reconfigurable metasurface unit cell array 162. The receiver device 178 may be any other device and may include the AP 144, the base station 146, or any other computing device described herein. Additionally, the information handling system 100 and receiver device 178 may be capable of transmitting wireless data using, for example, EM waves that include 5G mm wave lengths such as those included within the 20-50 GHz range or WiFi wavelengths such as 2.4 GHz, 5 GHZ, 6 GHz or others to be used with later versions of WiFi. Thus, in an embodiment, the reconfigurable metasurface unit cell array 162 is capable of relaying these types of mm waves.

In an embodiment, the wireless interface adapter 134 may operate in accordance with any wireless data communication standards. To communicate with a wireless local area network and/or the receiver device 178, standards including IEEE 802.11 WLAN standards (e.g., IEEE 802.11ax-2021 (Wi-Fi 6E, 6 GHZ)), IEEE 802.15 WPAN standards, WWAN such as 3GPP or 3GPP2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof. Via wireless communications from wireless adapter 134 under any particular WLAN or WAN wireless protocols, information handling system 100 may operate as a transmitting or receiving wireless device of RF signals across a wireless network 142 in a radiofrequency environment according to embodiments of the present disclosure.

In some embodiments, a hardware processing resource executes machine readable code instructions of software or firmware to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing machine readable code instructions of software or firmware as well as hardware implementations or any combination.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes machine readable code instructions, parameters, and profiles 118 or receives and executes machine readable code instructions, parameters, and profiles 118 responsive to a propagated signal, so that a hardware device connected to a network 142 may communicate voice, video, or data over the network 142. Further, the machine readable code instructions, parameters, and profiles 118 may be transmitted or received over the network 142 via the network interface device or wireless interface adapter 134.

The information handling system 100 may include a set of machine readable code instructions, parameters, and profiles 118 that may be executed to cause the computer system to perform any one or more of the methods or computer-based functions disclosed herein. For example, machine readable code instructions, parameters, and profiles 118 may be executed by a hardware processor 102, GPU 106, EC 104, APU 108, NPU 110, or any other hardware processing resource and may include software agents, or other aspects or components used to execute the methods and systems described herein. Various software modules comprising application machine readable code instructions, parameters, and profiles 118 may be coordinated by an operating system (OS) 122, and/or via an application programming interface (API) include a unified device API described herein. An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 may be a wireless transmitting computing device to operatively communicate with a receiver wireless computing device (e.g., another information handling system, an AP 144, a base station 146, etc.) via an intermediary-placed reconfigurable metasurface unit cell array 162 in an RF environment. This reconfigurable metasurface unit cell array 162 may be configured to relay or otherwise reflect wireless EM waves transmitted from the information handling system 100 and may extend the wireless range or improve signal of the information handling system 100 in communications with a target wireless device. Again, these EM waves may include any type of EM wave including low-band, mid-band, or high-band millimeter-wave EM waves. These may include 600-900 MHz, 1.7-6 GHz, and 24-47 GHz, among other frequencies. In the embodiments herein, the polarization of the reflected EM wave for reflected RF waves may be changed from the polarization of the incident EM waves by the operation of the reconfigurable metasurface unit cell array 162.

The reconfigurable metasurface unit cell array 162 may include a plurality of reconfigurable metasurface unit cells 164-1, 164-2, such as the first reconfigurable metasurface unit cell 164-1 and a second reconfigurable metasurface unit cell 164-2 is shown in FIG. 1. It is appreciated that the reconfigurable metasurface unit cell array 162 may contain any number of reconfigurable metasurface unit cells 164-1, 164-2. In one example embodiment, the reconfigurable metasurface unit cell array 162 may contain two-hundred and fifty-six reconfigurable metasurface unit cells 164-1, 164-2 arranged in a sixteen-by-sixteen array. It is appreciated that the reconfigurable metasurface unit cell array 162 may include any plurality of reconfigurable metasurface unit cells 164-1, 164-2 in any arrangement of those unit cells 164-1, 164-2. As described herein, the reconfigurable metasurface unit cells 164-1, 164-2 within the reconfigurable metasurface unit cell array 162 may be used to, in real-time, to dynamically adjust the polarization of the incoming EM waves from a transmitting source (e.g., the wireless antenna 140 of the wireless interface adapter 134 of the information handling system 100) to a receiver device (e.g., an AP 144, base station 146) to a second polarization state in reflected EM waves of the reflected RF signal according to embodiments herein.

In an embodiment, each of the reconfigurable metasurface unit cells 164-1, 164-2 may include a plurality of metallization nodes 166-1, 166-2. Although FIG. 1 shows only two metallization nodes as a first metallization node 166-1 and a second metallization node 166-2 in each reconfigurable metasurface unit cells 164-1, 164-2, the present specification contemplates that a top surface of each of the plurality of reconfigurable metasurface unit cells 164-1, 164-2 may include more than two metallization nodes 166-1, 166-2 embedded in or formed on a first dielectric layer. The reconfigurable metasurface unit cells 164-1, 164-2 may each comprise eleven metallization nodes 166-1, 166-2 as shown in some example embodiments described below, although any number in a semicircle is contemplated. In an embodiment, these metallization nodes 166-1, 166-2 may be arranged in a semicircular configuration on this top surface with a gap formed between a first metallization node 166-1 and, in an embodiment, the eleventh metallization node around the semicircle. In an embodiment, the metallization nodes 166-1, 166-2 may be formed on to a surface of a first dielectric layer (not shown) that electrically insulates the metallization nodes 166-1, 166-2 from other components and elements of the reconfigurable metasurface unit cells 164-1, 164-2. The semicircular metallization nodes 166-1, 166-2 formed on the first dielectric layer form a grating layer to enhance or suppress specific polarization components in reflecting the EM waves of the RF signals at the reconfigurable metasurface unit cells 164-1, 164-2 in embodiments herein. Control of the enhancement or suppression of specific polarization components may be controlled by reconfigurable coupling via a plurality of on a corresponding metal-insulator-transition (MIT) node membranes 168-1, 168-2 of a reconfiguration layer for coupling with a metasurface layer of each of the reconfigurable metasurface unit cells 164-1, 164-2 in embodiments herein.

Each of the reconfigurable metasurface unit cells 164-1, 164-2 may also include a plurality of MIT node membranes 168-1, 168-2 in a reconfiguration layer. Although FIG. 1 shows only two MIT node membranes 168-1, 168-2, the present specification contemplates that more than two MIT node membranes 168-1, 168-2 may be formed onto a second dielectric layer (not shown) below the first dielectric layer with each MIT node membrane 168-1, 168-2 formed corresponding to a metallization node 166-1, 166-2 formed above it. In one example embodiment described below, each of the reconfigurable metasurface unit cells 164-1, 164-2 may include eleven MIT node membranes 168-1, 168-2, although any number in a semicircle is contemplated. In an embodiment, these MIT node membranes 168-1, 168-2 may be arranged in a semicircular configuration on this second dielectric layer with a gap formed between the first MIT node membranes 168-1 and, in an embodiment, the eleventh MIT node membranes. In an embodiment, the MIT node membranes 168-1, 168-2 may be formed on to the surface of a second dielectric layer that electrically insulates the MIT node membranes 168-1, 168-2 from other components and elements of the reconfigurable metasurface unit cells 164-1, 164-2, including metallization nodes 166-1, 166-2 formed on the first dielectric layer above in the metasurface unit cells 164-1 or 164-2.

In an embodiment, the MIT node membranes 168-1, 168-2 may be made of any phase change material that includes volatile and non-volatile phase change materials. For example, the volatile phase change materials may include vanadium dioxide (VO₂), tungsten-doped vanadium dioxides, and titanium sesquioxide (Ti₂O₃). Other examples include non-volatile phase change materials that include germanium telluride (GeTe), antimony telluride (SbTe), and chalcogenide (GeSbTe). It is appreciated that an MIT node membrane 168-1, 168-2 may be formed on a second dielectric layer below each of the metallization nodes 166-1, 166-2 on the first dielectric layer. As such, in an embodiment, the eleven or other number of metallization nodes 166-1, 166-2 formed into a semicircular configuration are matched vertically below with a commensurate number of MIT node membranes 168-1, 168-2 also formed into a corresponding semicircular configuration. Thus, the gap between the first metallization node 166-1 and the eleventh or last metallization node in the semicircle may also have the gap between the first MIT node membrane 168-1 and the eleventh or last MIT node membrane aligned.

In an embodiment, of those phase change materials may be in an insulative state or conductive state that is switchable by a heat pulse. However, where heat pulse is applied to each of the MIT node membranes 168-1, 168-2, the phase change material transitions from an amorphous insulative state into a crystalline, conductive state or vice-versa. As described herein, as the phase change material of the MIT node membranes 168-1, 168-2 transitions into a conductive state, those conductive MIT node membranes 168-1 or 168-2 facilitate the conductive coupling of the each of the corresponding individual metallization nodes 166-1, 166-2 to the C-shaped resonator 172 formed below the second dielectric layer as a reflective metasurface layer in each reconfigurable metasurface unit cell 164-1, 164-2.

Thus, as described herein, a C-shaped resonator 172 is placed below the second dielectric layer and onto a surface of a base substrate (not shown) such as a printed circuit board (PCB) as a metasurface layer for coupling to the metallization nodes 166-1, 166-2 via any activated or conductive MIT node membranes 168-1, 168-2. As described, the C-shaped resonator 172 may include a gap formed therein. This gap also aligns with the gap between the first metallization node 166-1 and the eleventh or last metallization node as well as the gap between the first MIT node membrane 168-1 and the eleventh or last MIT node membrane as described herein.

In addition to the formation of the MIT node membranes 168-1, 168-2 onto the second dielectric layer, a plurality of heaters 170-1, 170-2 may be formed around, at least a portion of each of the MIT node membranes 168-1, 168-2. In an embodiment, these heaters 170-1, 170-2 may be formed around the circumference of the respective MIT node membranes 168-1, 168-2. In an embodiment, each of the heaters 170-1, 170-2 be addressable via operatively coupled contact pads 174. These contact pads 174 may electrically couple each of the plurality of heaters 170-1, 170-2 to the metasurface PMU 180 that supplies a voltage to each of the heaters 170-1, 170-2 via a metasurface battery 182 or a metasurface A/C power adapter 184 to generate heat pulses at the heaters 170-1 and 170-2 corresponding to the respective MIT node membranes 168-1, 168-2.

Each of the heaters 170-1, 170-2 of each of the reconfigurable metasurface unit cells 164-1, 164-2 may be matched with a grounding source arm (not shown) to permit flow of current to pulse heat. This grounding source arm and voltage source arms may be formed around portions of their respective MIT node membranes 168-1, 168-2. In one embodiment, the grounding source arms may be formed about half of the circumference of the MIT node membranes 168-1, 168-2 and the voltage source arms around the other half such that a voltage gap is formed for current flow for the respective plurality of heaters 170-1, 170-2. This gap provides for a voltage difference between the plurality of grounding source arms and the plurality of voltage source arms for current at the heaters 170-1, 170-2 thereby allowing the heaters 170-1, 170-2 to pulse heat at the phase change material of the MIT node membranes 168-1, 168-2 in order to transition the MIT node membranes 168-1, 168-2 from an insulative state to a conductive state.

During operation, the reconfigurable metasurface unit cell array 162 may have received, from a transmitting device or receiving device in wireless network management, an intended polarization state of a transmitted EM wave of an RF signal incident to the surface of the reconfigurable metasurface unit cell array 162 as well as a desired received polarization state at a receiver wireless device. In an embodiment, the reconfigurable metasurface unit cell array 162 may receive EM wave polarization shift instructions out of band describing a type of polarization of the EM wave that is to be reflected towards a receiving device via the reconfigurable metasurface unit cell array 162. In other embodiments, the reconfigurable metasurface unit cell array 162 may be formed with a set of EM wave polarization shift instructions that may determine polarization shift or a transitioning polarization shift predetermined for the reconfigurable metasurface unit cell array 162 and that is shared to known to the transmitting and receiving wireless device in a radiofrequency environment such that their antenna systems may operate accordingly.

In an embodiment, EM wave polarization shift instructions may be received at or determined at the metasurface controller 176 for processing. In an embodiment, the metasurface controller 176 may execute machine readable code instructions of an EM wave polarization management module 178. Execution of the EM wave polarization management module 178 allows the metasurface controller 176 to provide as input, the EM wave polarization instructions and provide, as output instructions regarding which of the heaters 170-1, 170-2 of which of the reconfigurable metasurface unit cells 164-1, 164-2 is to be activated in order to transition the phase change material of the MIT node membranes 168-1, 168-2 from an insulative state to a conductive state as described herein. As described herein, this changing of the MIT node membranes 168-1, 168-2 into a conductive state cause the C-shaped resonator 172 of each of the reconfigurable metasurface unit cells 164-1, 164-2 to be conductively coupled to those metallization nodes 166-1, 166-2 above the activated MIT node membranes 168-1, 168-2 to alter surface impedance to fine-tune adjust anisotropy within the metasurface unit cell 164-1 or 164-2. This adjustment to the anisotropy of the reconfigurable metasurface unit cell or cells 164-1, 164-2 is used for rotating and modifying the polarization state of the incident EM wave to a second polarization state in the reflected EM wave of the reflected RF signal. This selective activation or phase changing of the MIT node membranes 168-1, 168-2 allows the reconfigurable metasurface unit cells 164-1, 164-2 to create a macroscopic EM boundary condition that reflects the EM wave with the desired polarization state. It is appreciated that a plurality of reconfigurable metasurface unit cells 164-1, 164-2 may be activated pursuant to the instructions from the metasurface controller 176 to cooperate with each other in order to create a desired polarization state of the reflected EM wave. This reconfiguration capability of each of the reconfigurable metasurface unit cells 164-1, 164-2 and the reconfigurable metasurface unit cell array 162 enables reconfigurable metasurface unit cell array 162 to fine-tune the polarization of reflected EM waves, switching between linear, circular, and elliptical polarizations or implement other complex polarization patterns. This allows the reconfigurable metasurface unit cell array 162 to be used to increase security related to wireless transmissions such that those antenna not capable of receiving EM waves at that second polarization state of a reflected RF signal cannot intercept these wireless transmissions.

Additionally, in an embodiment, the reconfigurable metasurface unit cell array 162 may be operatively coupled to a metasurface PMU 180 and controlled via a metasurface controller 176. In an embodiment, a field programmable gate array (FPGA) circuit microchip or other hardware controller may also be used at the reconfigurable metasurface unit cell array 162 in order to individually address the contact pads 174 at each of the heaters 170-1, 170-2 and direct the metasurface PMU 180 to provide a voltage to the contact pads 174. In an embodiment, the power needed to operate the reconfigurable metasurface unit cell array 162 may be low such that the metasurface battery 182 may be sufficient to heat pulse the individual heaters 170-1, 170-2 in order to switch the MIT node membranes 168-1, 168-2 from an insulative state to a conductive state or vice versa. Alternatively, the metasurface PMU 180 may include a metasurface A/C power adapter 184 that may be used to provide this power to the heaters 170-1, 170-2 pursuant to instructions provided from the metasurface controller 176 as described herein.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

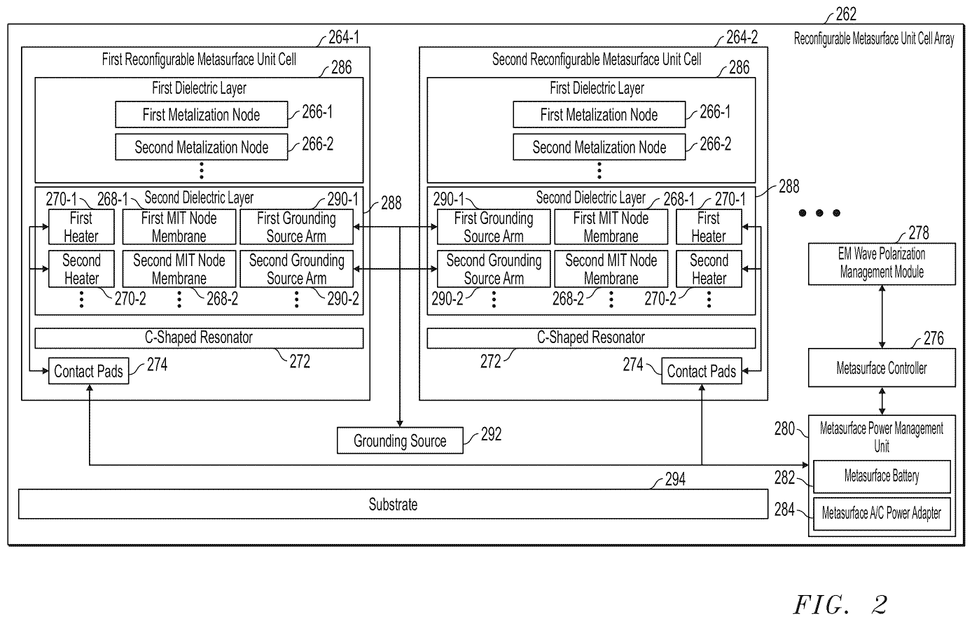

FIG. 2 is a block diagram illustrating a metasurface unit cell array 262 comprising a plurality of unit cells according to an embodiment of the present disclosure. It is appreciated that, in some embodiments, the reconfigurable metasurface unit cell array 262 may serve to reflect EM waves of RF signals that were transmitted from a transmitting device such as an information handling system (e.g., FIG. 1, 100) with a receiving device such as an AP (e.g., FIG. 1, 144) or a base station (e.g., FIG. 1, 146) in an RF environment. It is appreciated that any of these devices may serve as either the transmitting device or receiving device and the reconfigurable metasurface unit cell array 262 may be used to relay a plurality of wireless transmissions within an RF environment.

Again, the reconfigurable metasurface unit cell array 262 may include a plurality of reconfigurable metasurface unit cells 264-1, 264-2, such as the first reconfigurable metasurface unit cell 264-1 and a second reconfigurable metasurface unit cell 264-2 is shown in FIG. 2. It is appreciated that the reconfigurable metasurface unit cell array 262 may contain any number of reconfigurable metasurface unit cells 264-1, 264-2. In one example embodiment, the reconfigurable metasurface unit cell array 262 may contain two-hundred and fifty-six reconfigurable metasurface unit cells 264-1, 264-2 arranged in a sixteen-by-sixteen array. It is appreciated that the reconfigurable metasurface unit cell array 262 may include any plurality of reconfigurable metasurface unit cells 264-1, 264-2 in any arrangement of those unit cells 264-1, 264-2. As described herein, the reconfigurable metasurface unit cells 264-1, 264-2 within the reconfigurable metasurface unit cell array 262 may be used to, in real-time, dynamically adjust the polarization of the incoming EM waves from a transmitting source (e.g., the wireless antenna 240 of the wireless interface adapter 234 of an information handling system) in reflected EM waves of a reflected RF signal to a receiver device according to embodiments herein.

In an embodiment, each of the reconfigurable metasurface unit cells 264-1, 264-2 may include a plurality of metallization nodes 266-1, 266-2. Although FIG. 2 shows only two metallization nodes 266-1, 266-2 (a first metallization node 266-1 and a second metallization node 266-2), the present specification contemplates that a top surface of each of the plurality of reconfigurable metasurface unit cells 264-1, 264-2 may include more than two metallization nodes 266-1, 266-2. The metallization nodes 266-1, 266-2 serve as a grating layer of the reconfigurable metasurface unit cells 264-1, 264-2 with adjustable impedance to alter anisotropy of the reconfigurable metasurface unit cells 264-1, 264-2 for enhanced or suppressed polarization components such that the second polarization state of reflected EM waves may be altered. In an embodiment, the reconfigurable metasurface unit cells 264-1, 264-2 may each comprise eleven metallization nodes 266-1, 266-2 as shown in some embodiments described herein, but any number are contemplated for use with the reconfigurable metasurface unit cells 264-1, 264-2 herein. In an embodiment, these metallization nodes 266-1, 266-2 may be arranged in a semicircular configuration on this grating layer top surface of the reconfigurable metasurface unit cells 264-1, 264-2 with a gap formed between a first metallization node 266-1 and, in an embodiment, the eleventh or last metallization node. In an embodiment, the metallization nodes 266-1, 266-2 may be formed on to the surface of a first dielectric layer 286 that electrically insulates the metallization nodes 266-1, 266-2 from other components and elements of the reconfigurable metasurface unit cells 264-1, 264-2. In an embodiment, these metallization nodes 266-1, 266-2 may be made of a metal such as copper or gold.

Each of the reconfigurable metasurface unit cells 264-1, 264-2 may also include a plurality of MIT node membranes 268-1, 268-2 to form a reconfiguration layer of the reconfigurable metasurface unit cells 264-1, 264-2. Although FIG. 2 shows only two MIT node membranes 268-1, 268-2, the present specification contemplates that more than two MIT node membranes 268-1, 268-2 may be formed onto a second dielectric layer 288 below the first dielectric layer 286. In some embodiments described below, each of the reconfigurable metasurface unit cells 264-1, 264-2 may include eleven MIT node membrane 268-1, 268-2, but any number are contemplated for use with the reconfigurable metasurface unit cells 264-1, 264-2 herein. In an embodiment, these MIT node membranes 268-1, 268-2 may be arranged in a semicircular configuration on this second dielectric layer 288 with a gap formed between the first MIT node membranes 268-1 and, in an embodiment, the eleventh or last MIT node membranes. In an embodiment, the MIT node membranes 268-1, 268-2 may be formed on to the surface of a second dielectric layer 288 that electrically insulates the MIT node membranes 268-1, 268-2 from other components and elements of the reconfigurable metasurface unit cells 264-1, 264-2.

In an embodiment, the MIT node membranes 268-1, 268-2 may be made of any phase change material that includes volatile and non-volatile phase change materials. For example, the volatile phase change materials may include vanadium dioxide (VO₂), tungsten-doped vanadium dioxides, and titanium sesquioxide (Ti₂O₃). Other examples include non-volatile phase change materials that include germanium telluride (GeTe), antimony telluride (SbTe), and chalcogenide (GeSbTe). It is appreciated that a MIT node membrane 268-1, 268-2 may be placed below an aligned under each of the metallization nodes 266-1, 266-2 on the first dielectric layer 286. As such, in an embodiment, the eleven metallization nodes 266-1, 266-2 formed into a semicircular configuration are matched vertically below with a commensurate number of MIT node membranes 268-1, 268-2 also formed into a corresponding semicircular configuration. Thus, the gap between the first metallization node 266-1 and the eleventh or last metallization node and the gap between the first MIT node membrane 268-1 and the eleventh or last MIT node membrane are aligned.

In an embodiment, of those phase change materials may be in an insulative state or conductive state that is switchable by a heat pulse. However, where heat pulse is applied to each of the MIT node membranes 268-1, 268-2, the phase change material transitions from an amorphous insulative state into a crystalline, conductive state or vice-versa. As described herein, as the phase change material of the MIT node membranes 268-1, 268-2 transitions into a conductive state, those conductive MIT node membranes 268-1 or 268-2 facilitate the conductive coupling of the each of the corresponding individual metallization nodes 266-1, 266-2 to the C-shaped resonator 172 formed below the second dielectric layer as a reflective metasurface layer in each reconfigurable metasurface unit cell 264-1, 264-2.

Thus, as described herein, a C-shaped resonator 272 is placed below the second dielectric layer 288 and onto the surface of a base substrate 294 such as a printed circuit board (PCB). As described, the C-shaped resonator 272 may include a gap formed therein. This gap also aligns with the gap between the first metallization node 266-1 and the eleventh or last metallization node as well as the gap between the first MIT node membrane 268-1 and the eleventh or last MIT node membrane as described herein. In an embodiment, the C-shaped resonator 272 may be made of a metal such as copper or gold.

In addition to the formation of the MIT node membranes 268-1, 268-2 onto the second dielectric layer 288, a plurality of heaters 270-1, 270-2 may be formed around, at least a portion of each of the MIT node membranes 268-1, 268-2. In an embodiment, these heaters 270-1, 270-2 may be formed around the circumference of the respective MIT node membranes 268-1, 268-2. In an embodiment, each of the heaters 270-1, 270-2 may include addressable contact pads 274 to electrically couple each of the plurality of heaters 270-1, 270-2 to the metasurface PMU 280 that supplies a voltage to each of the heaters 270-1, 270-2 via a metasurface battery 282 or a metasurface A/C power adapter 284. In an embodiment, the heaters 270-1, 270-2 may be made of a metal that can be pulse heated at certain temperatures sufficient to phase change the MIT node membranes 268-1, 268-2 and still retain their conductive properties such as copper, tungsten, or gold.

Each of the heaters 270-1, 270-2 of each of the reconfigurable metasurface unit cells 264-1, 264-2 may include a voltage supply arm and grounding source arm 290-1, 290-2. This grounding source arm 290-1, 290-2 may be formed around at least a portion of their respective MIT node membranes 268-1, 268-2. In an embodiment, the grounding source arms 290-1, 290-2 may be formed about half of the circumference of the MIT node membranes 268-1, 268-2 and a voltage supply arm around the other portion of the circumference. Each of the grounding source arms 290-1, 290-2 and voltage source arms of respective heaters 270-1, 270-2 have a voltage gap between each of the plurality of grounding source arms 290-1, 290-2 and respective plurality of heaters 270-1, 270-2 to allow for current across heaters 290-2, 290-2 for generating pulse heating of the phase change material of the MIT node membranes 268-1, 268-2 in order to transition the MIT node membranes 268-1, 268-2 from an insulative state to a conductive state. In an embodiment, the grounding source arms 290-1, 290-2 may be made of a metal such as copper, tungsten, or gold. In an embodiment, the grounding source arms 290-1, 290-2 may each be operatively coupled to a grounding source 292 formed on the base substrate 294 of the reconfigurable metasurface unit cell array 262.

During operation, the reconfigurable metasurface unit cell array 262 may have received, from a transmitting device or receiving device in wireless network management, an intended polarization state of a transmitted EM wave of an RF signal incident to the surface of the reconfigurable metasurface unit cell array 262 as well as a desired received polarization state at a receiver wireless device. In an embodiment, the reconfigurable metasurface unit cell array 262 may receive EM wave polarization shift instructions out of band or have instructions stored at the reconfigurable metasurface unit cell array 262 describing a type of polarization of the EM wave that is to be reflected towards a receiving device via the reconfigurable metasurface unit cell array 262. In some embodiments, a wireless transmission may be received via a wireless interface adapter and antenna (not shown) at the reconfigurable metasurface unit cell array 262 to receive the EM wave polarization shift instructions out of band from a management information handling system, transmitter information handling system or receiver information handling system for the wireless network within a radiofrequency environment. In other embodiments, the reconfigurable metasurface unit cell array 262 may be formed with a set of EM wave polarization shift instructions that may determine polarization shift or a transitioning polarization shift predetermined for the reconfigurable metasurface unit cell array 262 and that is shared to known to the transmitting and receiving wireless device in a radiofrequency environment such that their antenna systems may operate accordingly.

In an embodiment, EM wave polarization shift instructions may be received at or determined at the metasurface controller 276 for processing. In an embodiment, the metasurface controller 276 may execute machine readable code instructions of an EM wave polarization management module 278. Execution of the EM wave polarization management module 278 allows the metasurface controller 276 to provide as input, the EM wave polarization instructions and provide, as output instructions regarding which of the heaters 270-1, 270-2 of which of the reconfigurable metasurface unit cells 264-1, 264-2 is to be activated in order to transition the phase change material of the MIT node membranes 268-1, 268-2 from an insulative state to a conductive state as described herein. As described herein, this changing of the MIT node membranes 268-1, 268-2 into a conductive state cause the C-shaped resonator 272 of each of the reconfigurable metasurface unit cells 264-1, 264-2 to be conductively coupled to those metallization nodes 266-1, 266-2 above the activated MIT node membranes 268-1, 268-2 to alter surface impedance to fine-tune adjust anisotropy within the metasurface unit cell 264-1 or 264-2. This adjustment to the anisotropy of the reconfigurable metasurface unit cell or cells 264-1, 264-2 is used for rotating and modifying the polarization state of the incident EM wave to a second polarization state in the reflected EM wave of the reflected RF signal. This selective activation or phase changing of the MIT node membranes 268-1, 268-2 allows the reconfigurable metasurface unit cells 264-1, 264-2 to create a macroscopic EM boundary condition that reflects the EM wave with the desired polarization state.

It is appreciated that a plurality of reconfigurable metasurface unit cells 264-1, 264-2 may be activated pursuant to the instructions from the metasurface controller 276 to cooperate with each other in order to create a desired polarization state of the reflected EM wave. This reconfiguration capability of each of the reconfigurable metasurface unit cells 264-1, 264-2 and the reconfigurable metasurface unit cell array 262 enables reconfigurable metasurface unit cell array 262 to fine-tune the polarization of reflected EM waves, switching between linear, circular, and elliptical polarizations or implement other complex polarization patterns. This allows the reconfigurable metasurface unit cell array 262 to be used to increase security related to wireless transmissions such that those antenna not capable of receiving EM waves at that second polarization state of a reflected RF signal cannot intercept these wireless transmissions.

Additionally, in an embodiment, the reconfigurable metasurface unit cell array 262 may be operatively coupled to a metasurface PMU 280 and controlled via a metasurface controller 276. In an embodiment, a field programmable gate array (FPGA) circuit microchip or other hardware controller may also be used at the reconfigurable metasurface unit cell array 262 in order to individually address the contact pads 274 at each of the heaters 270-1, 270-2 and direct the metasurface PMU 280 to provide a voltage to the contact pads 274. In an embodiment, the power needed to operate the reconfigurable metasurface unit cell array 262 may be low such that the metasurface battery 282 may be sufficient to heat to the individual heaters 270-1, 270-2 in order to switch the MIT node membranes 268-1, 268-2 from an insulative state to a conductive state or vice versa. Alternatively, the metasurface PMU 280 may include a metasurface A/C power adapter 284 that may be used to provide this power to the heaters 270-1, 270-2 pursuant to instructions provided from the metasurface controller 276 as described herein.

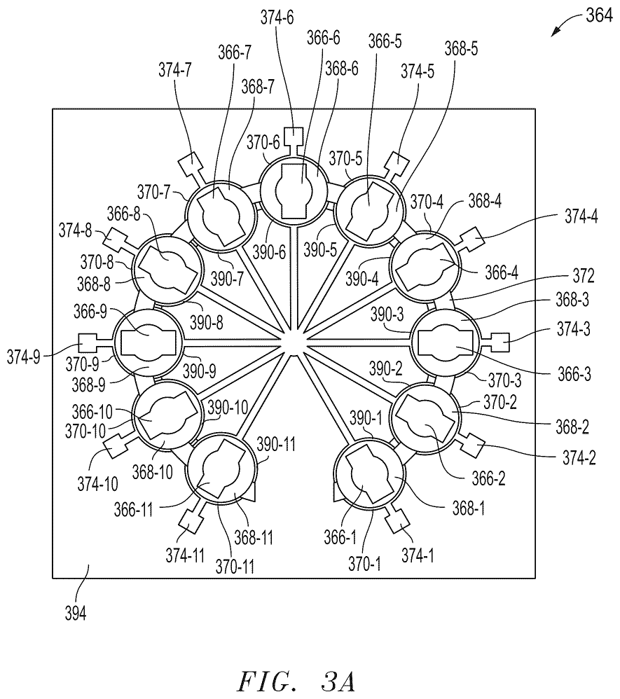

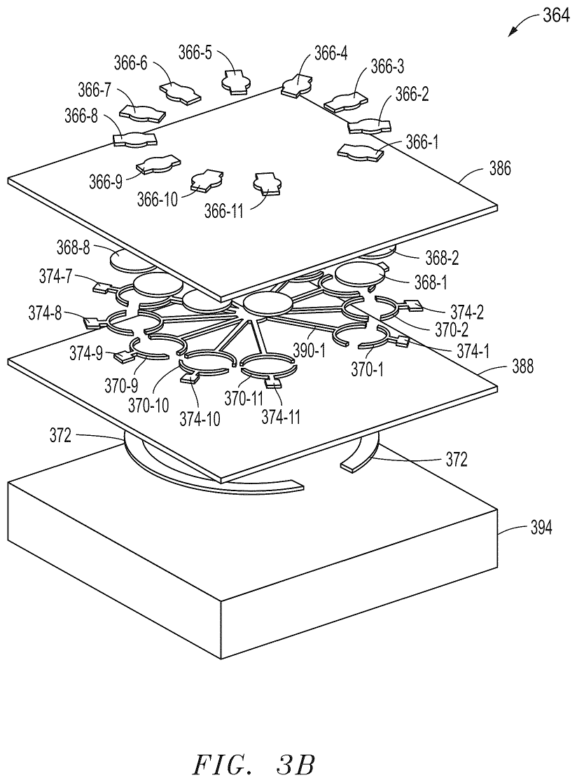

FIG. 3A is a top view diagram showing a reconfigurable metasurface unit cell 364 with metal-insulator-transition (MIT) node membranes 368-1 through 368-11 and metallization nodes 366-1 through 366-11 for tunable polarization state transition of reflected radiofrequency signals according to an embodiment of the present disclosure. Additionally, FIG. 3B is an exploded perspective view diagram showing a reconfigurable metasurface unit cell 364 with metal-insulator-transition (MIT) node membranes 368-1 through 368-11 and metallization nodes 366-1 through 366-11 for tunable polarization state transition of reflected radiofrequency signals according to an embodiment of the present disclosure. It is appreciated that this single reconfigurable metasurface unit cell 364 may be one of the plurality of the reconfigurable metasurface unit cells 364 that are arranged in rows and columns across a surface of the reconfigurable metasurface unit cell array (e.g., FIG. 1, 162). It is appreciated that, due to the arrangement of the diagrams, not all of the elements are shown and/or called out. However, it is appreciated that similar elements perform similar functions and include similar arrangements as described in FIGS. 1 and 2, for example.

As described herein, the reconfigurable metasurface unit cell 364 may include a plurality of metallization nodes 366-1 through 366-11. Although FIG. 3 shows eleven metallization nodes 366-1 through 366-11, the present specification contemplates that a top surface of each of the plurality of reconfigurable metasurface unit cell 364 of the reconfigurable metasurface unit cell array may include any number of metallization nodes 366-1 through 366-11. In an embodiment, the reconfigurable metasurface unit cell 364 depicts plural metallization nodes 366-1 through 366-11, as shown in FIGS. 3A and 3B, that are arranged in a semicircular configuration on the top surface of the first dielectric layer 386 with a gap formed between the first metallization node 366-1 and the eleventh metallization node 366-11. The semi-circular arrangement of metallization nodes 366-1 through 366-11 corresponds to C-shaped resonator 372 formed in the substrate layers below the metallization nodes 366-1 through 366-11. In an embodiment, the first dielectric layer 386 electrically insulates the metallization nodes 366-1 through 366-11 from other components and elements of the reconfigurable metasurface unit cell 364. In an embodiment, these metallization nodes 366-1 through 366-11 may be made of a metal such as copper or gold.

The reconfigurable metasurface unit cell 364 may also include a plurality of MIT node membranes 368-1 through 368-11. Although FIGS. 3A and 3B shows eleven MIT node membranes 368-1 through 368-11, the present specification contemplates that more or fewer than the eleven MIT node membranes 368-1 through 368-11 may be formed onto a second dielectric layer 388 below the first dielectric layer 386. In an embodiment, these MIT node membranes 368-1 through 368-11 may be arranged in a semicircular configuration on this second dielectric layer 388 with a gap formed between a first MIT node membranes 368-1 and the eleventh or last MIT node membrane 368-11. In an embodiment, the MIT node membranes 368-1 through 368-11 may be formed on to the surface of the second dielectric layer 388 that electrically insulates the MIT node membranes 368-1 through 368-11 from other components and elements of the reconfigurable metasurface unit cell 364, although the dimension of the spacing of the metal-insulator-transition (MIT) node membranes 368-1 through 368-11 under the metallization nodes 366-1 through 366-11 provides for enhanced coupling when metal-insulator-transition (MIT) node membranes 368-1 through 368-11 are in an active or conductive state for tunable control of polarization state transition of reflected radiofrequency signals in embodiments herein.

In an embodiment, the MIT node membranes 368-1 through 368-11 may be made of any phase change material that includes volatile and non-volatile phase change materials. For example, the volatile phase change materials may include vanadium dioxide (VO₂), tungsten-doped vanadium dioxides, and titanium sesquioxide (Ti2O3). Other examples include non-volatile phase change materials that include germanium telluride (GeTe), antimony telluride (SbTe), and chalcogenide (GeSbTe). It is appreciated that a MIT node membranes 368-1 through 368-11 may be placed below each of the metallization nodes 366-1 through 366-11 on the first dielectric layer 386 such that the MIT node membranes 368-1 through 368-11, when in a conductive state, enhance electromagnetic coupling with the surface metallization nodes 366-1 through 366-11 on the first dielectric layer 386 and with the c-shaped resonator 372 under the metallization nodes 366-1 through 366-11 to change the anisotropic properties of the reconfigurable metasurface unit cell 364 in embodiments of the present disclosure. As such, in an embodiment, the eleven or other number of metallization nodes 366-1 through 366-11 are formed into a semicircular configuration that are matched vertically below with a commensurate number of MIT node membranes 368-1 through 368-11 also formed into a corresponding semicircular configuration. Thus, the gap between the first metallization node 366-1 and the eleventh or last metallization node 366-11 and the gap between the first MIT node membrane 368-1 and the eleventh or last MIT node membrane 368-11 are aligned.

In an embodiment, of those phase change materials described, these phase change materials may remain in a static insulative state or conductive state that is switchable with pulsed heat. However, where pulsed heat is applied to each of the MIT node membranes 368-1 through 368-11, the phase change material transitions into a crystalline state that is conductive or to an amorphous state that is dielectric. As described herein, as the phase change material of the MIT node membranes 368-1 through 368-11 transitions into a conductive state, they facilitate the conductive coupling of the each of the individual metallization nodes 366-1 through 366-11 to the C-shaped resonator 372 placed below the second dielectric layer 388. As the phase change material of the MIT node membranes 368-1 through 368-11 transitions from a conductive state to a dielectric state, this suppresses the conductive coupling of the each of the individual metallization nodes 366-1 through 366-11 to the C-shaped resonator 372 placed below the second dielectric layer 388. In this way, the surface impedance of the reconfigurable metasurface unit cell 364 may be fine-tuned such that the anisotropy is altered to change degrees of phase shift or amplitude modification to tune components of the polarization state in reflected RF signals.

Thus, as described herein, a C-shaped resonator 372 is placed below the second dielectric layer 388 and onto a surface of a base substrate 394 such as a printed circuit board (PCB). As described, the C-shaped resonator 372 may include a gap formed therein. This gap also aligns with the gap between the first metallization node 366-1 and the eleventh metallization node 366-11 as well as the gap between the first MIT node membrane 368-1 and the eleventh MIT node membrane 368-11 as described herein. In an embodiment, the C-shaped resonator 372 may be made of a metal such as copper or gold.

In addition to the formation of the MIT node membranes 368-1 through 368-11 onto the second dielectric layer 388 which may be thermally conductive, a plurality of heaters 370-1 through 370-11 may be formed around, at least a portion of each of the MIT node membranes 368-1 through 368-11. In an embodiment, voltage supply arms of these heaters 370-1 through 370-11 may be formed around about half of the circumference of the respective MIT node membranes 368-1 through 368-11. In an embodiment, each of the heaters 370-1 through 370-11 may include a contact pad 374-1 through 374-11. These contact pads 374-1 through 374-11 may electrically couple each of the plurality of heaters 370-1 through 370-11 to the metasurface PMU (e.g., FIG. 2, 280) that supplies a voltage to each of the voltage supply arms of heaters 370-1 through 370-11 via a metasurface battery or a metasurface A/C power adapter. In an embodiment, the heaters 370-1 through 370-11 may be made of a metal that can be heated at certain temperatures sufficient to phase change the MIT node membranes 368-1 through 368-11 and still retain their conductive properties such as copper, tungsten, or gold.

Each of the heaters 370-1 through 370-11 of the reconfigurable metasurface unit cell 364 may also interface with a grounding source arm 390-1 through 290-11. These grounding source arms 390-1 through 390-11 may be formed around at least a portion of their respective MIT node membranes 368-1 through 368-11. In an embodiment, the grounding source arms 390-1 through 390-11 may be formed about half of the circumference of the MIT node membranes 368-1 through 368-11. However, each of the grounding source arms 390-1 through 390-11 and respective heaters 370-1 through 370-11 may not touch each other thereby forming a voltage difference between each of the plurality of grounding source arms 390-1 through 390-11 and respective voltage source arms of the plurality of heaters 370-1 through 370-11. This gap creates a voltage difference between the plurality of grounding source arms 390-1 through 390-11 and the plurality of heaters 370-1 through 370-11 thereby allowing the heaters 370-1 through 370-11 to pulse heat through the phase change material of the MIT node membranes 368-1 through 368-11 in order to transition the MIT node membranes 368-1 through 368-11 from an insulative state to a conductive state, or vice-versa. In an embodiment, the grounding source arms 390-1 through 390-11 may be made of a metal such as copper, tungsten, or gold. In an embodiment, the grounding source arms 390-1 through 390-11 may each be operatively coupled to a grounding source (e.g., FIG. 2, 292) formed under the base substrate 394 of the reconfigurable metasurface unit cell array.

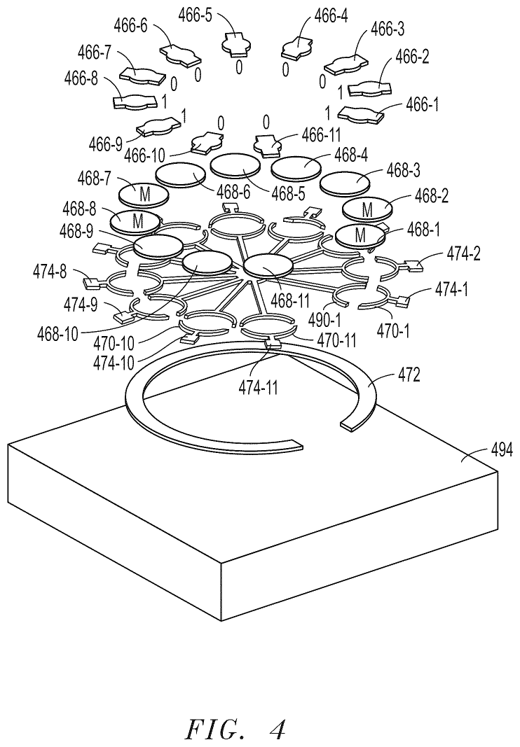

FIG. 4 is an exploded perspective view diagram showing a reconfigurable metasurface unit cell 464 with MIT node membranes 368-1 through 368-11 at various insulative states and conductive states for adjustment of polarization states of reflected RF signals according to an embodiment of the present disclosure. As described herein, the reconfigurable metasurface unit cell 364 may be operatively coupled to a metasurface PMU that supplies a voltage to each of the heaters 370-1 through 370-11 via their respective contact pads 374-1 through 374-11. It is appreciated that, due to the arrangement of the diagrams, not all of the elements are shown and/or called out. However, it is appreciated that similar elements perform similar functions and include similar arrangements as described in FIGS. 1 and 2, for example. Additionally, it is noted that the first dielectric layer (e.g., FIG. 3, 386) and the second dielectric layer (e.g., FIG. 3, 388) have been removed to show the relative positioning of the metallization nodes 466-1 through 466-11, the MIT node membranes 468-1 through 468-11, the heaters 470-1 through 470-11, and the C-shaped resonator 472 to each other vertically over base substrate 494.

During operation, the reconfigurable metasurface unit cell array may have received, from a transmitting device or receiving device in wireless network management, an intended polarization state of a transmitted EM wave of an RF signal incident to the surface of the reconfigurable metasurface unit cell array as well as a desired received polarization state at a receiver wireless device. In an embodiment, the reconfigurable metasurface unit cell array may receive EM wave polarization shift instructions out of band or have instructions stored at the reconfigurable metasurface unit cell array describing a type of polarization of the EM wave that is to be reflected towards a receiving device via the reconfigurable metasurface unit cell array.

In an embodiment, EM wave polarization shift instructions may be received at or determined at the metasurface controller for processing. In an embodiment, the metasurface controller may execute machine readable code instructions of an EM wave polarization management module. Execution of the EM wave polarization management module allows the metasurface controller to provide as input, the EM wave polarization instructions and provide, as output instructions regarding which of the heaters 470-1 through 470-11, of each reconfigurable metasurface unit cells 464 are to be activated in order to transition the phase change material of the MIT node membranes 468-1 through 468-11 from an insulative state to a conductive state as described herein. As described herein, this changing of the MIT node membranes 468-1 through 468-11 into a conductive state causes enhanced coupling of the C-shaped resonator 472 with those metallization nodes 466-1 through 466-11 above the activated MIT node membranes 468-1 through 468-1 to alter surface impedance to fine-tune adjust anisotropy within the metasurface unit cell 464-1. This adjustment to the anisotropy of the reconfigurable metasurface unit cell 464 is used for rotating and modifying the polarization state of the incident EM wave to a second polarization state in the reflected EM wave of the reflected RF signal. This selective activation or phase changing of the MIT node membranes 468-1 through 468-11 allows the reconfigurable metasurface unit cells 464-1 to create a macroscopic EM boundary condition that reflects the EM wave with the desired polarization state.

As shown in FIG. 4, the first MIT node membrane 468-1, second MIT node membrane 468-2, eighth MIT node membrane 468-8, and ninth MIT node membrane 468-9 have been activated to a conductive state as indicated by an “M” marker placed on them. This was accomplished by providing a voltage, from the metasurface PMU to the respective contact pads 474-1, 474-2, 474-8, 474-9 so that the first heater 470-1, second heater 470-2, eighth heater 470-8, and ninth heater 470-9 pulse heat to the MIT node membranes 468-1, 468-2, 468-8, 468-9.

This selective activation or phase changing of MIT node membranes 468-1, 468-2, 468-8, 468-9 among the plurality of MIT node membranes 468-1 through 468-11 allows the reconfigurable metasurface unit cells 464 to create tuned changes to surface impedance such that macroscopic EM boundary conditions that reflect the EM wave do so with the desired shift to its polarization state. It is appreciated that a plurality of reconfigurable metasurface unit cells 464 may be activated pursuant to the instructions from the metasurface controller to cooperate with each other in order to create a desired shift in polarization state of the reflected EM wave. This reconfiguration capability of each of the reconfigurable metasurface unit cells 464 and the reconfigurable metasurface unit cell array as a whole enables reconfigurable metasurface unit cell array to fine-tune the polarization of reflected EM waves, switching between linear, circular, and elliptical polarizations. This allows the reconfigurable metasurface unit cell array to be used to increase security related to wireless transmissions such that those antenna not capable of receiving EM waves at that polarization cannot intercept these wireless transmissions.

In an embodiment, to create the complex and customized profiles, various equations may be implemented by the hardware metasurface controller to calculate which of the heaters 470-1 through 470-11 to activate in order to change the phase change material of the MIT node membranes 468-1 through 468-11 from a conductive state or back to an insulative state or vice versa. For example, an elliptical polarization may be calculated using the following equations to set the array of surface impedance across the metallization nodes 466-1 through 466-11 addressing any plurality of the heaters 470-1 through 470-11 associated with the MIT node membranes 468-1 through 468-11:

$${( \frac{{∈}_{x}}{{E}_{R} + {E}_{L}} )}^{2} + {( \frac{{∈}_{y}}{{E}_{R} - {E}_{L}} )}^{2} = 1 \qquad Equation 1$$

$$with$$

$${∈}_{x} = \vec{{a}_{x}} {E}_{x} cos ( wt + \frac{π}{2} ) \qquad Equation 2$$

$$and$$

$${∈}_{y} = \vec{{a}_{y}} {E}_{y} cos ( wt ) \qquad Equation 3$$

It is appreciated that other equations may be implemented by the hardware metasurface controller may be used to calculate linear and circular polarizations. These equations may allow, as instructed by the EM wave polarization instructions, for the hardware metasurface controller to dynamically change the polarization of incoming EM waves so as to increase the security of the wireless transmissions and/or allow for wireless communication between a transmitting device and a receiving device. As the hardware metasurface controller calculates the polarization of the reflected EM wave, the hardware metasurface controller may also determine which of the heaters 470-1 through 470-11 to activate in each of the reconfigurable metasurface unit cells 464 of the reconfigurable metasurface unit cell array in order to engineer the phase and amplitude response across the surface of the reconfigurable metasurface unit cell array such that, together, they create a macroscopic EM boundary condition that reflects the EM wave of the reflected RF signal with the desired, shifted second polarization state.

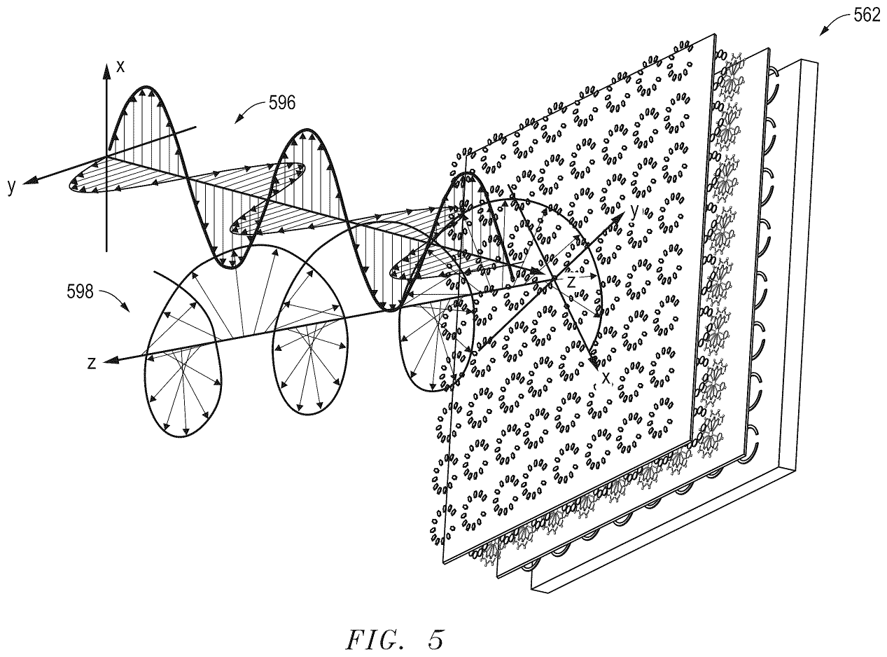

FIG. 5 is an exploded perspective view diagram showing a reconfigurable metasurface unit cell array 562 interfacing with an incident EM wave of an incident RF signal 596 at a first polarization state and reflecting that EM wave of a reflected RF signal 598 off of the surface of the reconfigurable metasurface unit cell array 562 at a different polarization state according to an embodiment of the present disclosure. In the example presented in FIG. 5, the incoming EM wave includes an electrical component “E” and a magnetic component “B” that are orthogonal to each other in direction of propagation of the RF signal 596 incident to the surface of the reconfigurable metasurface unit cell array 562. This incoming EM wave of the incident RF signal 596 is a linearly polarized EM wave in the shown example embodiment. The reflected EM waves of the reflected RF signal 596 may have an adjusted polarization state different from the incoming polarization state according to embodiments herein. For example, the reflected EM wave includes an electrical component “E” and a magnetic component “B” that are orthogonal to each other in direction of propagation of the reflected RF signal 598 away from the surface of the reconfigurable metasurface unit cell array 562. This reflected EM wave of the reflected RF signal 598 is converted to an elliptically polarized EM wave in the shown example embodiment.

In some embodiments, EM wave polarization instructions are transmitted to the reconfigurable metasurface unit cell array 562 from a transmitting, receiving or management information handling system of a wireless network in an RF environment. These EM wave polarization instructions may include expected polarization state of RF signals 596 transmitted to and second polarization state of reflected RF signal 598 to be reflected from are transmitted to the reconfigurable metasurface unit cell array 562 to a target wireless device in the RF environment in embodiments herein. These EM wave polarization instructions may be transmitted to and received out of band or in band via a wireless antenna and radio at the reconfigurable metasurface unit cell array 562. In one example embodiment, this incoming EM wave of incident RF signal 596 may include EM wave polarization instructions embedded in the data being transmitted that is received by the hardware metasurface controller and used to determine which, if any, polarization phase change to make to reflect the appropriate polarized reflected EM wave 598. In the example presented in FIG. 5, this reflected EM wave 598 may be an elliptically polarized reflected EM wave 598 that includes a relative phase and amplitude change in the reflected EM wave 598 of the orthogonal electrical and magnetic components of the original linear incoming EM wave 596.

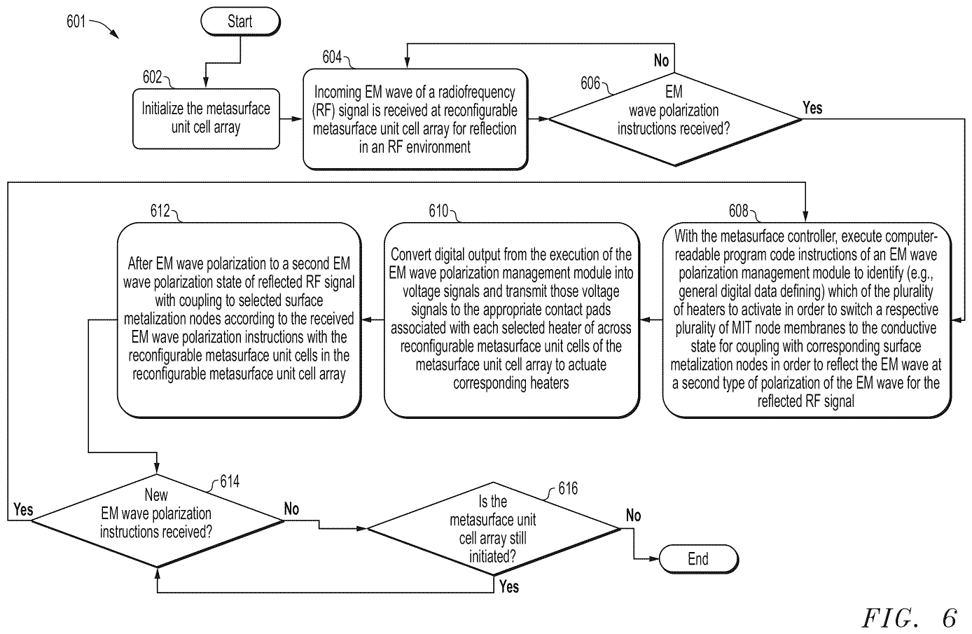

FIG. 6 is a flow diagram of a method of securely wirelessly transmitting data via a reconfigurable metasurface unit cell array having addressable metal-insulator-transition (MIT) node membranes for dynamic polarization shift of electromagnetic (EM) waves of reflected radiofrequency (RF) signals in an RF environment according to an embodiment of the present disclosure.

At block 602, the method 601 may include initiating the reconfigurable metasurface unit cell array. In an embodiment, the reconfigurable metasurface unit cell array may be initiated by a user actuating a power button on the reconfigurable metasurface unit cell array. The metasurface PMU may then proceed to power a metasurface controller such as a hardware metasurface controller, metasurface wireless adapter, or other components in order to prepare the reconfigurable metasurface unit cell array to receive EM wave polarization instructions and incoming EM wave at a first polarization state as described in embodiments herein. In an embodiment, the reconfigurable metasurface unit cell array may be placed on a surface in an RF environment where incoming EM wave may be relayed (e.g., reflected) from a source wireless device in order to reach a receiving device. These surfaces may include an A-cover of an information handling system, a wall, and the side of a building, among other surfaces in an RF environment where millimeter EM waves, for example, may be relayed around objects that would otherwise prevent penetration.

At block 604, the method 601 may include receiving the incoming EM waves at the reconfigurable metasurface unit cell array. As described herein, any of a plurality of EM waves of RF signals may be received at the reconfigurable metasurface unit cell array in a first polarization state. In embodiments herein, EM wave polarization instructions may be received or stored at the reconfigurable metasurface unit cell array describing a first type of polarization of the incoming EM waves of the incident RF signals and a conversion to a second type of polarization state that the reflected EM waves shall have for the reflected RF signals reflected towards a receiving device via the reconfigurable metasurface unit cell array. This data may be received at the metasurface controller onboard the reconfigurable metasurface unit cell array for processing as described herein. In various embodiments, the EM wave polarization instructions may be received in-band, such as within the incoming RF signals, or out of band from one or more of the transmitting, receiving, or a management wireless device in the RF environment.

Therefore, at block 606, the method 601 may include determining whether EM wave polarization instructions have been received or detected at the metasurface hardware controller or retrieved from memory storage at the reconfigurable metasurface. In one example, the EM wave polarization instructions have been received or detected in the signal relayed between the source wireless device and the target receiving wireless device. In an embodiment, these EM wave polarization instructions may be provided via a wireless connection from, for example, a transmitting wireless information handling system or other source wireless computing device that provides data descriptive of the radiofrequency environment in which the transmitting source wireless computing device and receiving wireless device are located. Where no EM wave polarization instructions have been received, the hardware metasurface controller does not change any polarization characteristics of the incoming EM wave at the reconfigurable metasurface unit cell array and the reconfigurable metasurface unit cell array continues in its current state with the reconfigurable metasurface unit cell array relaying the incoming EM wave to a receiving device without changing the polarization of the incoming EM wave.

However, where the EM wave polarization instructions have been received, the method 601 continues to block 608. At block 608, the method 800 further includes executing, with the hardware metasurface controller, machine readable code instructions of an EM wave polarization management module to identify and generate digital data defining which of the plurality of heaters to activate in order to switch a respective plurality of MIT node membranes to the conductive state or to a dielectric state. In this way, the in order to tune surface impedances of the reconfigurable metasurface unit cells to reflect the EM wave at the second type of polarization of the reflected EM wave for the reflected RF signal. Execution of the EM wave polarization management module allows the metasurface controller to provide as input, the EM wave polarization instructions including current first polarization state of the incoming RF signal and provide, as output, instructions regarding which of the heaters of which of the reconfigurable metasurface unit cells is to be activated or deactivated in order to transition the phase change material of the MIT node membranes from an insulative state to a conductive state, or vice-versa, to adjust polarization phase-shift and amplitude components of the reflected RF signal as described in embodiments herein.

Thus, at block 610, the method 601 also includes converting the digital output from the execution of the EM wave polarization management module into voltage signals and transmitting those voltage signal pulses to the appropriate contact pads associated with each appropriate heaters of each appropriate reconfigurable metasurface unit cell of the metasurface unit cell array to actuate corresponding heaters for pulsing heat. As shown in FIGS. 3A and 3B and described herein, each reconfigurable metasurface unit cell of the reconfigurable metasurface unit cell array includes a plurality of metallization nodes. In an embodiment, the reconfigurable metasurface unit cells may each comprise eleven metallization nodes as shown in, for example, FIGS. 3A and 3B. In an embodiment, these metallization nodes may be arranged in a semicircular configuration on this top surface with a gap formed between a first metallization node and, in an embodiment, the eleventh metallization node. In an embodiment, the metallization nodes may be formed on to a surface of a first dielectric layer that electrically insulates the metallization nodes from other components and elements of the reconfigurable metasurface unit cells.

Each of the reconfigurable metasurface unit cells may also include a plurality of MIT node membranes. In an embodiment, each of the reconfigurable metasurface unit cells may include eleven MIT node membranes. In an embodiment, these MIT node membranes may be arranged in a semicircular configuration on this second dielectric layer with a gap formed between the first MIT node membranes and the eleventh MIT node membrane. In an embodiment, the MIT node membranes may be formed on to the surface of a second dielectric layer that electrically insulates the MIT node membranes from other components and elements of the reconfigurable metasurface unit cells but allows for electromagnetic coupling between activated, conductive MIT node membranes and the surface metallization nodes to adjust surface impedance thereon.

In an embodiment, the MIT node membranes may be made of any phase change material that includes volatile and non-volatile phase change materials. For example, the volatile phase change materials may include vanadium dioxide (VO₂), tungsten-doped vanadium dioxides, and titanium sesquioxide (Ti₂O₃). Other examples include non-volatile phase change materials that include germanium telluride (GeTe), antimony telluride (SbTe), and chalcogenide (GeSbTe). It is appreciated that a MIT node membrane may be placed below each of the metallization nodes on the first dielectric layer. As such, in an embodiment, the eleven metallization nodes formed into a semicircular configuration are matched vertically below with a commensurate number of MIT node membranes also formed into a corresponding semicircular configuration. Thus, the gap between the first metallization node and the eleventh metallization node and the gap between the first MIT node membrane and the eleventh MIT node membrane are aligned.

In an embodiment, of those phase change materials described, these phase change materials may be switchable between a conductive and dielectric insulative state with pulses of heat. Where heat pulses are applied to each of the MIT node membranes, the phase change material transitions between a crystalline state that is conductive and an amorphous state that is dielectric. As described herein, as the phase change material of the MIT node membranes transitions into a conductive state, those activated MIT node membranes facilitate the EM conductive coupling of the each of the individual metallization nodes to the C-shaped resonator placed below the second dielectric layer. Further, as the phase change material of the MIT node membranes transitions into a dielectric state, those inactivated MIT node membranes suppress the EM conductive coupling of the each of the individual metallization nodes to the C-shaped resonator placed below the second dielectric layer in other embodiments. This allows for granular adjustment of surface impedance on the metasurface unit cells and control of phase shift and amplitude components for adjustments to convert the polarization state from a first polarization state to a second, adjusted polarization state in reflected RF signals.

Thus, as described herein, a C-shaped resonator is placed below the second dielectric layer and onto the surface of a base substrate such as a PCB. As described, the C-shaped resonator may include a gap formed therein. This gap also aligns with the gap between the first metallization node and the eleventh metallization node as well as the gap between the first MIT node membrane and the eleventh MIT node membrane as described herein. In an embodiment, the C-shaped resonator may be made of a metal such as copper or gold.

In addition to the formation of the MIT node membranes onto the second dielectric layer, a plurality of heaters may be formed around, at least a portion of each of the MIT node membranes to provide pulsed heat as addressed with voltage signals at respective contact pads. These contact pads may electrically couple each of the plurality of heaters to the metasurface PMU that supplies a voltage to each of the heaters via a metasurface battery or a metasurface A/C power adapter. In an embodiment, the heaters may be made of a metal that can be heated at certain temperatures sufficient to change the phase of the MIT node membranes and still retain their conductive properties such as copper, tungsten, or gold.

The method 601 may continue at block 612, therefore, with converting digital output from the metasurface PMU, as directed by the hardware metasurface controller altering the EM wave polarization according to the received EM wave polarization instructions with the selected adjustment of MIT node membranes between conductive and dielectric states in the reconfigurable metasurface unit cells in the reconfigurable metasurface unit cell array. Again, the applied voltage and current to each of the heaters causes the phase change material of the MIT node membranes to switch between an insulative state or a conductive state or vice versa. Depending on the arrangement of active MIT node membranes across the reconfigurable metasurface unit cells and across the array, the phase and amplitude components of the polarization state for incident EM waves of incoming RF signals is tunably converted to a second polarization state for the reflected EM waves of reflected RF signals outgoing from the surface of the reconfigurable metasurface unit cell array.

At block 614, the method 601 continues by detecting whether a new set of EM wave polarization instructions have been received or detected at the metasurface controller. Where a new set of EM wave polarization instructions have been received or detected, the method 601 continues to block 608 with the hardware metasurface controller executing those processes described herein. Where no new EM wave polarization instructions have been received, the method 601 continues to block 616.

At block 616, the method 601 includes determining if the reconfigurable metasurface unit cell array is still initiated. Where the reconfigurable metasurface unit cell array is still initiated, the method 601 proceeds to block 614 with the hardware metasurface controller monitoring to determine if new EM wave polarization instructions have been received as described herein. Where the reconfigurable metasurface unit cell array is no longer initiated, the method 601 may end here.

The processes or steps and aspects of the operation of the embodiments herein and discussed herein, such as those of FIG. 6 for example, need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A reconfigurable metasurface unit cell array to manipulate reflection of an electromagnetic (EM) wave for an incident radiofrequency (RF) signal in an RF environment comprising:
a metasurface hardware controller and a metasurface power management unit (PMU) to provide power to the metasurface hardware controller;
a plurality of reconfigurable metasurface unit cells to receive the incident RF signal at a first polarization state, each reconfigurable metasurface unit cell including:
a plurality of metallization nodes disposed in a semicircular configuration on a first dielectric layer of an external surface of the reconfigurable metasurface unit cell;
a plurality of metal-insulator-transition (MIT) node membranes disposed in a corresponding semicircular configuration onto a surface of a second dielectric layer separated from the metallization nodes by the first dielectric layer;
a plurality of addressable heaters formed in the second dielectric layer for each of the plurality of MIT node membranes to selectively pulse heat to phase change material of each of the plurality of MIT node membranes to switch the MIT node membranes between an insulative state and conductive state; and
a conductive c-shaped resonator formed below the second dielectric layer to electromagnetically couple to a plurality of metallization nodes corresponding to the MIT node membranes that are switched to the conductive state; and
the metasurface hardware controller and the metasurface PMU to address selected heaters to activate the selection of MIT node membranes in the conductive state to dynamically adjust impedance across the external surface of the reconfigurable metasurface unit cell to convert the incident RF signal in the first polarization state to a reflected RF signal in a second polarization state via the reconfigurable metasurface unit cell array.

2. The reconfigurable metasurface unit cell array of claim 1 further comprising:
the plurality of addressable heaters including voltage source arms and grounding source arms formed around at least a portion of the MIT node membranes and addressable via contact pads operatively coupled to the voltage source arms and the metasurface PMU as controlled by the metasurface hardware controller.

3. The reconfigurable metasurface unit cell array of claim 1, wherein the plurality of MIT node membranes are made of volatile phase change material selected from vanadium dioxide (VO₂), tungsten-doped vanadium dioxides, or titanium sesquioxide (Ti₂O₃).

4. The reconfigurable metasurface unit cell array of claim 1, wherein the plurality of MIT node membranes are made of non-volatile phase change material selected from germanium telluride (GeTe), antimony telluride (SbTe), or chalcogenide (GeSbTe).

5. The reconfigurable metasurface unit cell array of claim 1, wherein the first polarization state and second polarization state are selected from linear polarization, circular polarization, or elliptical polarization and the second polarization state is different from the first polarization state.

6. The reconfigurable metasurface unit cell array of claim 1 further comprising:
the metasurface hardware controller and the metasurface PMU to address selected heaters to deactivate a second selection of MIT node membranes to the dielectric state to suppress EM coupling to the corresponding metallization node to dynamically adjust impedance across the external surface of the reconfigurable metasurface unit cell to convert the incident RF signal in the first polarization state to the reflected RF signal in the second polarization state via the reconfigurable metasurface unit cell array.

7. The reconfigurable metasurface unit cell array of claim 1 further comprising:
the metasurface hardware controller receiving EM wave polarization instructions from a wireless device in the radiofrequency environment indicating the first polarization state and the second polarization state; and
the metasurface hardware controller the executing machine readable code instructions of an EM wave polarization management module to determine control of the metasurface PMU to pulse heat to the selection of MIT node membranes to convert the incident RF signal from the first polarization state to the reflected RF signal in the second polarization state via the reconfigurable metasurface unit cell array based on the EM wave polarization instructions.

8. The reconfigurable metasurface unit cell array of claim 1 further comprising:
the metasurface hardware controller executing machine readable code instructions of an EM wave polarization management module to determine control of the metasurface PMU to pulse heat to the selection of MIT node membranes to convert the incident RF signal from the first polarization state to the reflected RF signal in the second polarization state via the reconfigurable metasurface unit cell array based on EM wave polarization instructions; and
the reconfigurable metasurface unit cell array to directionally reflect the reflected RF signal to a receiver wireless device in the RF environment also having the EM wave polarization instructions indicating the second polarization state.

9. A method of securely wirelessly transmitting data via a reconfigurable metasurface unit cell array using conversion from incident radiofrequency (RF) signals a first polarization state to reflected RF signals in a second polarization state comprising:
receiving electromagnetic (EM) wave polarization instructions at a metasurface hardware controller from a wireless device in the radiofrequency environment indicating the first polarization state for the incident RF signals and the second polarization state to be used for the reflected RF signals;
receiving an EM wave of the incident RF signal in the first polarization state at the reconfigurable metasurface unit cell array from a transmitting device in the RF environment that is to be reflected towards a receiving device via the reconfigurable metasurface unit cell array, wherein the reconfigurable metasurface unit cell array comprises a plurality of reconfigurable metasurface unit cells;
transitioning a plurality of metal-insulator-transition (MIT) node membranes between an insulative state and conductive state of a phase change material disposed in a semicircular configuration onto a surface of a second dielectric layer formed below a first dielectric layer via heat pulses from a plurality of addressable heaters formed around at least a portion of each of the plurality of MIT node membranes in the second dielectric layer;
electromagnetically coupling a plurality of metallization nodes disposed in a corresponding semicircular configuration on the first dielectric layer over the MIT node membranes for EM coupling select metallization nodes with a conductive c-shaped resonator formed below the second dielectric layer to adjust surface impedance of the reconfigurable metasurface unit cells to convert the incident RF signal in the first polarization state to the reflected RF signal in the second polarization state; and
executing, at a metasurface hardware controller, computer-readable program code of an EM wave polarization management module to identify which of the plurality of heaters to activate in order to activate a selected plurality of MIT node membranes to the conductive state across the reconfigurable metasurface unit cell array in order to reflect the EM wave of the reflected RF signal in the second polarization towards a receiver wireless device in the RF environment having the second polarization state from the EM wave polarization instructions.

10. The method of claim 9, wherein the receiver wireless device in the RF environment must utilize the second polarization state from the EM wave polarization instructions to receive and decode the reflected RF signal from the reconfigurable metasurface unit cell.

11. The method of claim 9, wherein each of the plurality of addressable heaters comprises a contact pad operatively coupled to each of the plurality of addressable heaters and to a metasurface power management unit (PMU) to provide voltage pulses controlled by the metasurface hardware controller based on the EM wave polarization instructions to pulse heat to activate the selected plurality of MIT node membranes.

12. The method of claim 9, wherein the first polarization state and second polarization state are selected from linear polarization, circular polarization, or elliptical polarization and the second polarization state is different from the first polarization state.

13. The method of claim 9 further comprising:
pulsing voltage to selected addressable heaters, via the metasurface hardware controller and the metasurface PMU, to deactivate a second selection of MIT node membranes to the dielectric state to suppress EM coupling to the corresponding metallization node to dynamically adjust impedance across the external surface of the reconfigurable metasurface unit cell to convert the incident RF signal in the first polarization state to the reflected RF signal in the second polarization state via the reconfigurable metasurface unit cell array.

14. A reconfigurable metasurface unit cell array to manipulate reflection of an electromagnetic (EM) wave for an incident radiofrequency (RF) signal in an RF environment comprising:
a metasurface hardware controller and a metasurface power management unit (PMU) to provide power to the metasurface hardware controller;
a plurality of reconfigurable metasurface unit cells to receive the incident RF signal at a first polarization state, each reconfigurable metasurface unit cell including:
a plurality of metallization nodes disposed in a semicircular configuration on a first dielectric layer of an external surface of the reconfigurable metasurface unit cell;
a plurality of metal-insulator-transition (MIT) node membranes disposed in a corresponding semicircular configuration onto a surface of a second dielectric layer separated from the metallization nodes by the first dielectric layer;
a plurality of addressable heaters formed in the second dielectric layer for each of the plurality of MIT node membranes to selectively pulse heat to phase change material of each of the plurality of MIT node membranes to switch the MIT node membranes between an insulative state and conductive state; and
a conductive c-shaped resonator formed below the second dielectric layer to electromagnetically couple to a plurality of metallization nodes corresponding to the MIT node membranes that are switched to the conductive state; and
the metasurface hardware controller executing machine readable code instructions of an EM wave polarization management module to determine control of the metasurface PMU to pulse heat to the selection of MIT node membranes to transition to the conductive state and dynamically adjust impedance across the external surface of a reconfigurable metasurface unit cell to convert the incident RF signal from the first polarization state to the reflected RF signal in the second polarization state via the reconfigurable metasurface unit cell array based on received EM wave polarization instructions.

15. The reconfigurable metasurface unit cell array of claim 14 further comprising:
the plurality of addressable heaters each including a voltage source arm and a grounding source arm formed around at least a portion of the MIT node membrane and addressable via a contact pad operatively coupled to the voltage source arm and the metasurface PMU as controlled by the metasurface hardware controller.

16. The reconfigurable metasurface unit cell array of claim 14, wherein the plurality of MIT node membranes are made of volatile phase change material selected from vanadium dioxide (VO₂), tungsten-doped vanadium dioxides, or titanium sesquioxide (Ti₂O₃).

17. The reconfigurable metasurface unit cell array of claim 14, wherein the plurality of MIT node membranes are made of non-volatile phase change material selected from germanium telluride (GeTe), antimony telluride (SbTe), or chalcogenide (GeSbTe).

18. The reconfigurable metasurface unit cell array of claim 14 further comprising:
the metasurface hardware controller and the metasurface PMU to address selected heaters to deactivate a second selection of MIT node membranes to the dielectric state to suppress EM coupling to the corresponding metallization node to dynamically adjust impedance across the external surface of the reconfigurable metasurface unit cell to convert the incident RF signal in the first polarization state to the reflected RF signal in the second polarization state via the reconfigurable metasurface unit cell array.

19. The reconfigurable metasurface unit cell array of claim 14 further comprising:
the metasurface hardware controller receiving EM wave polarization instructions from a wireless device in the radiofrequency environment indicating the first polarization state for the incident RF signals and the second polarization state to be used for the reflected RF signals.

20. The reconfigurable metasurface unit cell array of claim 14 further comprising:
the metasurface hardware controller receiving EM wave polarization instructions from a wireless device in the radiofrequency environment indicating the first polarization state and the second polarization state; and
the metasurface hardware controller the executing machine readable code instructions of an EM wave polarization management module to determine control of the metasurface PMU to pulse heat to the selection of MIT node membranes to convert the incident RF signal from the first polarization state to the reflected RF signal in the second polarization state based on the EM wave polarization instructions such that a receiver wireless device in the RF environment must have the second polarization state from the EM wave polarization instructions to receive the reflected RF signal.
